(19) United States
(12) Patent Application Publication
(10) Pub. No.: US 2008/0122200 A1
(43) Pub. Date: May 29, 2008

(54) Device For Interconnecting Perambulators

(76) Inventor: Jenifer Lake, Neasden (GB)

Correspondence Address: Manelli Denison & Selter;Attn: William H. Bollman, 2000 M Street, NW, 7th Floor, Washington, DC, 20036, US

(21) Appl. No.: 11/791,275

(22) PCT Filed: Nov. 28, 2005
(86) PCT No.: PCT/GB2005/004540

§ 371 Date: May 22, 2007

(30) Foreign Application Priority Data
Nov. 26, 2004 (GB) 0426071.7

(51) Int. Cl. B60D 1/04

(52) U.S. Cl. 280/514

(57) ABSTRACT

A device for interconnecting perambulators comprising a coupling element and gripping members at opposing ends of the coupling element for gripping supporting members of the perambulators, thus allowing the perambulators to be coupled together. The gripping members have manually releasable jaws and the length of the coupling element is adjustable by relative translational movement of portions of the coupling element.

### BACKGROUND

The present invention generally relates to a device for interconnecting devices, and more specifically, but not exclusively, the invention relates to a device for interconnecting perambulators, pushchairs or buggies.

Dual pushchairs exist for transporting two children simultaneously. However, it may be required to only transport one child at a time, in which case it would be useful to detach the pushchairs to give parents or childminders the choice of having single or twin pushchairs. In addition, it may be desirable to connect any two perambulating devices, for example wheelchairs, or any other device that can be pushed. A device for connecting two single pushchairs would be particularly useful, as this would avoid the additional expense of purchasing both a twin pushchair and a single pushchair.

### PRIOR ART

It is known to use devices for coupling perambulating devices such as pushchairs and wheelchairs. U.S. Pat. No. 5,522,121 discloses a coupler for engaging and disengaging two buggies or baby strollers. The coupler device comprises two components that are spaced apart and coupled by a snap release connector. The two components are each attached to the frame of a stroller using clamps, the clamps being fixed to the frame by a bolt and wing nut arrangement. However, this coupler does not comprise a quick release mechanism, and the continuous fastening and unfastening of the clamps results in this device being very awkward and time-consuming to use.

U.S. Pat. No. 4,805,938 discloses a device for connecting two baby strollers together comprising a pair of bracket units spaced apart and clamped been frames of baby strollers. The bracket units are clamped together using a bolt and wing nut arrangement. However, the bracket units do not grip securely and releasably. This device would also be very inconvenient and time-consuming to use, as it does not comprise a quick release mechanism.

U.S. Pat. No. 5,529,427 discloses a wheelchair coupler apparatus having an elongated arm attached to a first wheelchair frame and a wheelchair attaching member attached to the elongated arm which extends and attaches to a second wheelchair frame by means of an engaging fastener. This apparatus is permanently clamped to one wheelchair and does not comprise a quick release mechanism. In addition, the spacing between wheelchairs cannot be varied because the elongate arm only extends laterally, not translationally.

U.S. Design 423994 discloses a coupler to join two strollers comprising an elongate bar and an attaching member at each end of the bar for attaching to the frames of baby strollers. However, this coupler does not allow the spacing between strollers to be varied, as the elongate bar only comprises one component and therefore cannot extend translationally. In addition, the attaching members cannot securely grip frames of a diameter smaller than the diameter of the attaching frames when they are in a dosed position.

The present invention arose in order to provide a device which overcomes disadvantages with the aforementioned couplers.

### SUMMARY OF THE INVENTION

One aspect of the present invention provides a device for interconnecting perambulators, having components that do not have to be clamped or screwed together before use: comprising: a coupling element extending laterally in a first direction; and fastening devices at opposing ends of the coupling element, each fastening device comprising opposing resilient jaw portions adapted to grip a support member of a pushchair, wherein the jaw portions are relatively hinged and adapted to be pivotable about an axis at an angle to the first direction.

A perambulator is any device that can be pushed, particularly any wheeled device for carrying persons, especially for carrying children.

The resilient jaw portions provide several advantages to the present invention. They allow the coupling device to be attached and detached from the support frames of perambulators very quickly, they provide superior grip to the support frames by being capable of fully encircling the support frame, and they can grip support frames of variable diameters, making this device adaptable to be used with any design or brand of perambulator. The jaw portions can be arranged so that just one of them moves about an axis at an angle to the coupling element.

In an alternative embodiment, both of the jaw portions can be attached to the coupling element in a hinged manner so that they can both move about a common pivot point. The jaw portions can include wings to allow for manual operation of the jaw portions and easier fastening and unfastening of the coupling device to the support members of the perambulator. The user can simply fasten and unfasten the coupling device to the support member of the perambulator instantly by applying light pressure to the wings, which then forces the jaws apart.

In one embodiment, each jaw portion comprises teeth and the jaw portions are arranged so that the teeth interdigitate when the jaws are in a dosed position. This allows for superior grip of the fastening members to the support members of the perambulator. It also allows the jaw portions to fully encircle any diameter of support members, and therefore any design or brand of perambulator.

Another aspect of the invention provides a device for connecting perambulators, comprising a coupling element extending translationally in a first direction and comprising at least two components adapted to be moveable relatively translational in the first direction to adjust the length of the coupling element in the first direction; and gripping members at opposing ends of the coupling element, the gripping members adapted to grip a support member of a pushchair, wherein the gripping members extend in a second direction substantially perpendicular to the first direction and the second direction is greater than a diameter of said gripping members when said gripping members are in a dosed position.

In one embodiment the angle between the first direction and the second direction can be varied so that the gripping members are adjustable to grip support members of perambulators that are not substantially perpendicular to the direction of extension of the coupling element.

The coupling element is translationally extendable to allow spacing between perambulators to be varied. This can be achieved by providing the at least two components of the coupling element with a first portion and a second portion, the first portion being adapted to translationally receive said second portion.

In one embodiment, the extendable coupling element can be locked in place. This can be achieved by providing at least one aperture in the first portion and at least one releasably engageable locking pin in the second portion adapted to engage the at least one aperture. Alternatively, the first portion can comprise at least one pair of opposing apertures, and said second portion at least one pair of opposing releasably engageable locking pins adapted to engage the at least one pair of opposing apertures provided in the first portion. The user of the coupling device can then extend the coupling element to give the desired spacing between perambulators by squeezing the locking pins together so that they disengage from the apertures and slide the second portion translationally with the first portion and releasing the locking pins to engage with another pair of apertures when the desired spacing is reached. The locking pins can be joined by a compressible spring arrangement so that they are easily compressed by the user when it is desired to unlock the second portion of the coupling element from the first portion, by disengaging the locking pins from the apertures, so as to change the length of the coupling element.

In one embodiment, at least one locking pin or pair of opposing locking pins engages me at least one aperture or pair of apertures at an angle substantially perpendicular to the first direction.

In an alternative embodiment, the gripping members at opposing ends of the translationally extendable coupling element can be provided with opposing resilient jaw portions. As in other embodiments described above, the jaw portions can be relatively hinged and adapted to be pivotable about an axis situated at an angle to the first direction, wherein the angle been the axis and the first direction can be substantially perpendicular. Additionally, the jaw portions can be adapted to be pivotable in a plane with the first direction. This allows the device to be used with perambulators having support members that are awkward to reach or of an irregular shape. The jaw portions can also comprise wings to allow easier manual operation; the jaw portions can be adapted to meet in a dosed position so as to fully encircle the support member, or be used with perambulators with support members of a large diameter so that they do not fully encircle the support member.

The jaw portions can also have a length greater than a diameter of the jaw portions when they are in a dosed position and each jaw portion can comprise teeth arranged to interdigitate when the jaws are in a dosed position to allow a better grip of the coupling device to the support member. Each of the jaw portions can also be attached to the coupling element in a hinged manner so that both of the jaw portions are free to move.

Embodiments of the invention will now be described with reference to the accompanying drawings, in which:

### BRIEF DESCRIPTION OF THE FIGURES

FIG. 1 is a schematic diagram of coupling devices coupling a pair of perambulators according to embodiments of the present invention;

FIG. 2A is a plan view of a coupling device according to a first embodiment;

FIG. 2B is a part sectioned diagram of the coupling device of the first embodiment;

FIG. 2C is a part-sectional diagram of the lock mechanism of the first embodiment in the disengaged position;

FIG. 3A is a schematic diagram of a gripping member for gripping a support member of a perambulator according to a second embodiment of the invention;

FIG. 3B is a schematic diagram of the gripping member of the second embodiment in an open position;

FIG. 4 is a side view of a gripping member for gripping a support member of a perambulator according to a third embodiment of the invention;

FIG. 5 is an exploded schematic view of an alternative embodiment of a gripping member with an adjustment means to vary the distance between first and second jaws;

FIG. 6 is an overall view of the embodiment shown in FIG. 5;

FIG. 7 is a sectional view, the embodiment shown in FIG. 9, along the line A-A;

FIG. 8 is a side elevational view of the embodiment shown in FIG. 5;

FIG. 9 is a plan view of the embodiment shown in FIG. 5;

FIG. 10 is a sectional view, of the embodiment shown in FIG. 8, along the line B-B; and

FIG. 11 is a plan view showing interdigitated fingers of the clamps.

### DETAILED DESCRIPTION OF PREFERRED EMBODIMENTS OF THE INVENTION

Although the present invention can be used with any perambulator, that is any device that can be pushed, it is particularly suited for use with children's pushchairs, where changing family requirements can create a need for adapting single pushchairs to a twin pushchair configuration, whereby two children can be pushed along simultaneously.

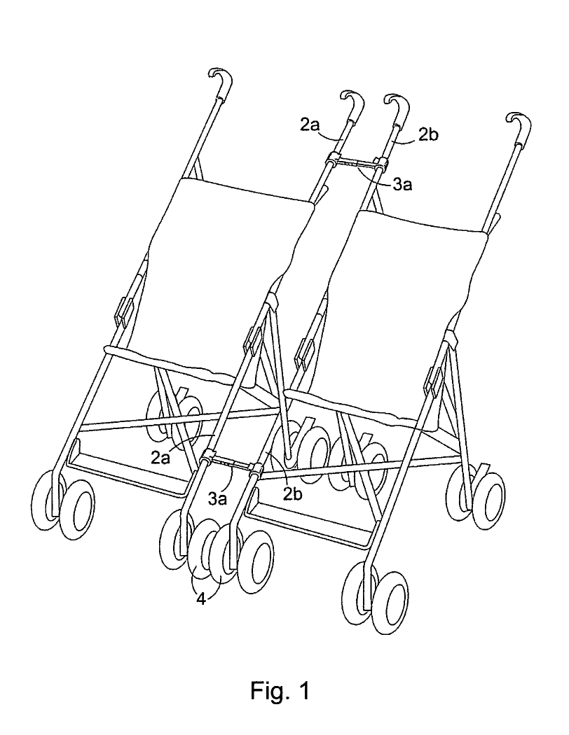

FIG. 1 shows a pair of perambulators 1 comprising support frames or members 2a and 2b and wheels 4. In this example the perambulators are children's pushchairs. Two coupling devices 3a and 3b connect the perambulators 1 by gripping the support members 2a and 2b and extending laterally been the support members 2a and 2b so that there is enough spacing been the perambulators 1 to allow the wheels 4 to rotate freely when the perambulators 1 are pushed. When the coupling devices 3a and 3b are attached to the support members 2a and 2b, the perambulators 1 are coupled so that one person is able to push both perambulators 1 at the same time. Alternatively the coupling devices 3a and 3b can be detached from the support members 2a and 2b so that the perambulators 1 can be used separately.

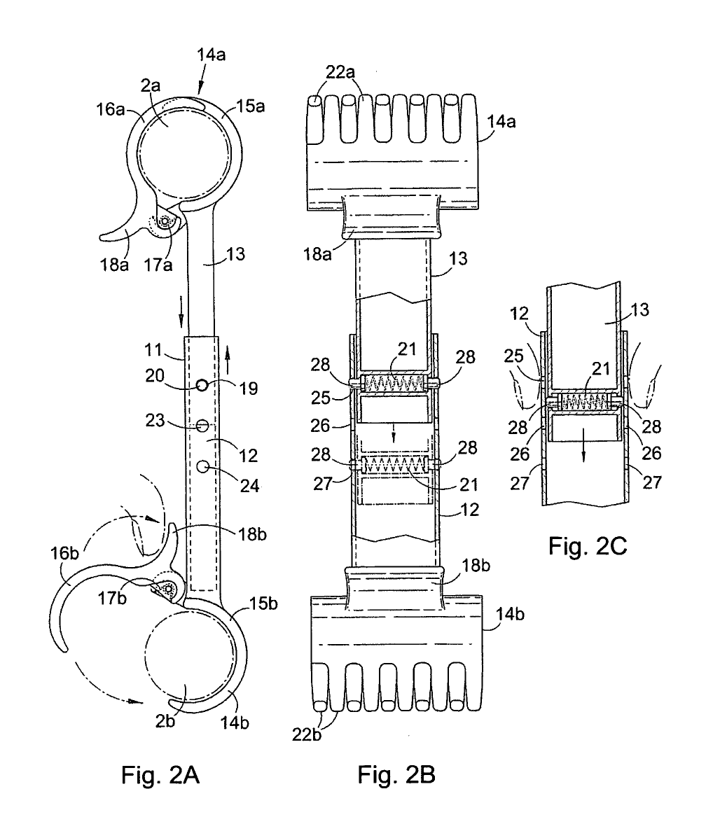

A first embodiment will now be described with reference to FIGS. 2A, 2B and 2C. Fastening gripping 14 members 14a and 14b for gripping the support members 2a and 2b of perambulators are at opposing ends of a coupling element 11. The coupling element 11 extends laterally been the gripping members 14a and 14b. The gripping members 14a and 14b comprise opposing jaw portions 15a and 15b and 16a and 16b. Each of the jaw portions 16a and 16b is hinged relatively to the jaw portions 15a and 15b about pivot pins forming axes 17a and 17 band the jaw portions 16a and 16b are free to move about the axes 17a and 17b, while the jaw portions 15a and 15b are fixed. The axes 17a and 17b extend at an angle to the direction of lateral extension of the coupling element 11. This angle can be 90° but it is not limited to this value. Wings 18a and 18b extending from the jaw portions 16a and 16b are provided for manual operation of the jaw portions 16a and 16b. Inner surfaces of the jaw portions 16a and 16b can be coated with a gripping surface, for example rubber, to improve grip.

The gripping members 14a and 14b are opened by exerting pressure on the wings 18a and 18b so that the jaw portions 16a and 16b move apart from the jaw portions 15a and 15b about the axes 17a and 17b. Jaw portions 15a and 15b and 16a and 16b are then placed around support members 2a and 2b on each perambulator and jaw portions 16a and 16b are then moved about the axes 17a and 17b until the gripping members 14a and 14b grip the support members 2a and 2b securely in order to fasten the device to each perambulator. The jaw portions 15a and 15b and 16a and 16b allow the gripping members 17a and 17b to have variable diameters so that they are able to grip support members of many different sizes. This means that the device of the present invention can be used to connect a wide range of different perambulators and is not limited to one brand or design. The jaw portions 15a and 15b and 16a and 16b enable the gripping members 14a and 14b to fully encircle the support members 2a and 2b, so as to provide a superior grip of the device to the perambulators, when the jaw portions 16a and 16b are fully dosed. Alternatively, the jaw portions 16a and 16b do not fully encircle the support members 2a and 2b and are therefore able to accommodate perambulators with large support members.

In this embodiment, coupling element 11 comprises an outer portion 12 and an inner portion 13. The outer portion 12 is adapted to translationally receive the inner portion 13 so that the coupling element can be extended and the spacing between perambulators varied as desired. The outer portion 12 of the coupling element 11 comprises apertures 19, 23 and 24, and the inner portion 13 of the coupling element 11 comprises a locking pin 20. The locking pin 20 is adapted to be resiliently engageable with the apertures 19, 23 and 24 so that the coupling element 11 can be extended to the desired length and locked in place so that it remains at that length until it is wished to change its length again.

When it is required to change the length of the coupling element 11, and therefore vary the spacing between perambulators, pressure is exerted on the locking pin 20 so that it disengages with the aperture 19. The inner portion 13 of the coupling element 11 is then able to slide inside the outer portion 12 so that the length of the coupling element 11 is varied. When the coupling element 11 reaches the required length, the locking pin 20 can then resiliently engage with either of the apertures 23 or 24 to provide a locking mechanism so that the coupling element 11 is secured at the desired length. Although the first portion 12 is illustrated as having three apertures, it is not restricted to having three apertures. The number and spacing of apertures in the first portion 12 can be varied so as to give an increased variety of lengths to which the coupling element 11 can be extended.

As can be seen in FIG. 2B, the gripping members 14a and 14b have jaw portions comprising teeth 22a and 22b and the coupling element 11 comprises a locking mechanism in which pairs of opposing apertures 25, 26 and 27 are provided in the outer portion 12 which engage a pair of opposing resiliently engageable locking pins 28 joined by a spring 21 provided in the inner portion 13 to form a locking mechanism that secures the coupling element 11 in place at a required length.

In this embodiment, when the gripping members 14a and 14b dose around the support members of the perambulators, the teeth 22a and 22b are able to interdigitate so as to provide a superior grip around the support members. In addition, as the teeth 22a and 22b interdigitate, they allow the device of the present application to be used with an even more varied range of perambulators, as the jaws are able to enclose diameters of support narrower than the diameter of the diameter of the gripping members 14a and 14b in a dosed position without teeth.

When the device is required to be extended, the pair of opposing locking pins 28 are depressed and the spring 21 allows them to disengage with the pair of opposing apertures 25. The outer portion 12 of the coupling element can then translationally receive the inner portion 13 until the spacing been the gripping members 14a and 14b is as required. The locking pins 28 can then engage with one of the opposing pairs of apertures 26 or 27. This is shown in more detail in FIG. 2C. Thus the pair of opposing releasably engageable locking pins and pairs of opposing apertures provided in this embodiment fixes the coupling element in place more securely at its preferred length.

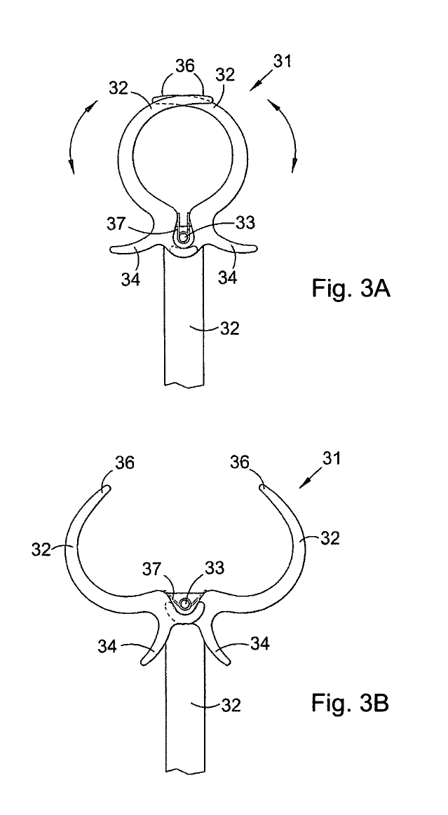

FIGS. 3A and 3B show a second embodiment in which gripping members 31 comprise opposing resilient jaw portions 32 and are provided on a coupling element 35, which extends laterally, as in the first embodiment. Only part of the device is shown in FIGS. 3A and 3B, but as with the first embodiment shown in FIGS. 2A and 2B, gripping members 31 are provided at opposing ends of the coupling element 35; i.e., the coupling element 35 extends laterally between gripping members 31. The jaw portions 32 are provided with interdigitated teeth 36 and are each attached to the coupling element 35 by a hinge arrangement 37 so that they are free to move about a common pivot point provided in the coupling element 35, which forms an axis 33. Therefore both jaw portions 32 can be opened and dosed. They can be moved at the same time, or independently of each other. The direction of lateral extension of the axis 33 forms an angle with the direction of lateral extension of the coupling element 35. This angle can be perpendicular but the jaw portions 32 can also each be hinged about an axis 33 that forms any other angle with the direction of lateral extension of the coupling element 35. Wings 34 are provided for ease of manual operation when opening and dosing the jaws 32. Jaws 32a and 32b can be coated with a gripping material such as rubber to improve grip. As in the first embodiment described above, gripping members 31 are provided at opposing ends of the coupling member 35.

FIG. 3A shows the jaw portions 32 in a partially dosed position and FIG. 3B shows the jaw portions 32 in a fully open position. When it is required that the gripping member 31 is attached to a perambulator, pressure is exerted on the wings 34, which causes the teeth 36 to move apart and the jaw portions 32 to open. The jaw portions 32 can be opened fully, as shown in FIG. 3B. This allows them to grip perambulators having support members with large diameters. Alternatively, if it is required to couple perambulators having support members with very small diameters, the teeth 36 can interdigitate so that the jaw portions 32 are fully dosed in a “clam-like” fashion. Thus this embodiment whereby the jaw portions are hinged so that they are each free to move, allows for superior grip of a perambulator, and allows the device of the present embodiment to be used with an even wider range of perambulatory devices.

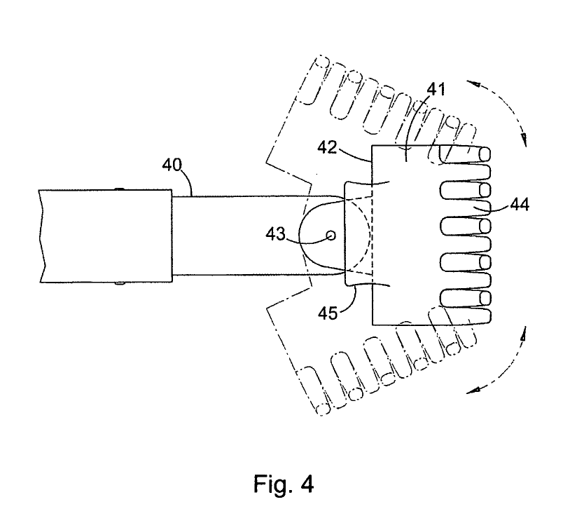

FIG. 4 shows a third embodiment in which a fastening gripping member 41 for gripping a support member of a perambulator is provided on a coupling element 40. Only a side view of a section of the device is shown here. As with the first embodiment, the coupling member 40 extends laterally between opposing gripping members 41.

The gripping member 41 extends laterally in a direction along an axis 42 and is attached to the coupling element 40 by a longitudinal pivot pin providing a pivot point 43. The gripping member 41 can be moved about the pivot point 43 in a plane with the direction of lateral extension of the coupling element 40 so that an angle been the axis 42 and the direction of lateral extension of the coupling element 40 can be varied. This further increases the versatility of the device, as it allows the gripping members to be adjusted so that two perambulators having support members that are difficult to reach or are not straight or perpendicular to the direction of extension of the coupling element 40 can still be quickly and easily interconnected and disconnected again. The gripping member 41 can also comprise jaw portions having interdigitated teeth 44 and wings 45 to allow for further ease of manual operation.

Thus an aspect of the present invention provides the advantage that it is able to couple any two designs or brands of perambulator, as the fastening devices provide jaw portions so that a wide range of diameter and thickness of perambulator support members can be gripped. It is not limited to use with two perambulators of the same brand or design. The jaw portions also provide superior grip of the perambulator support members.

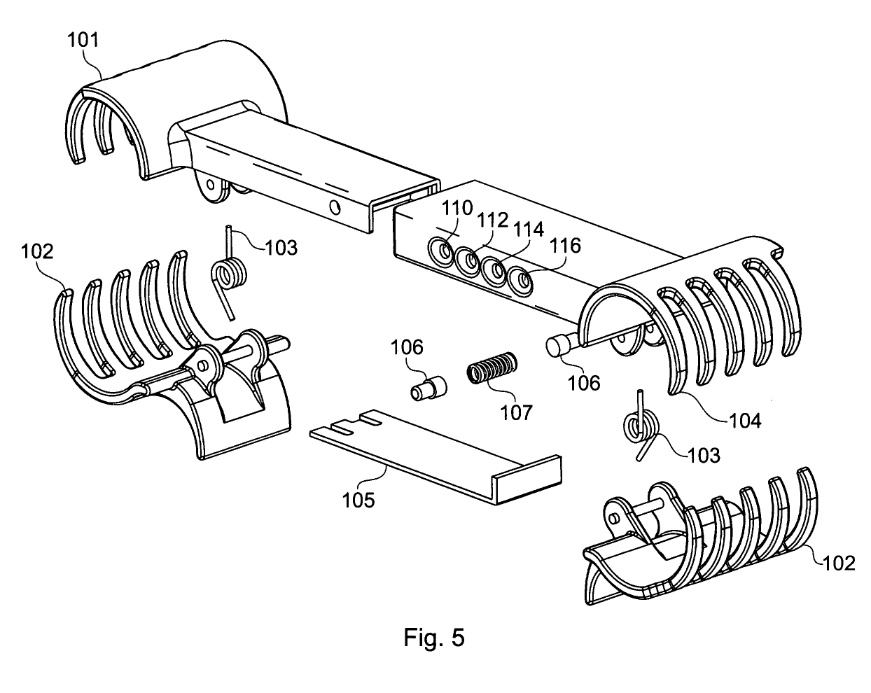

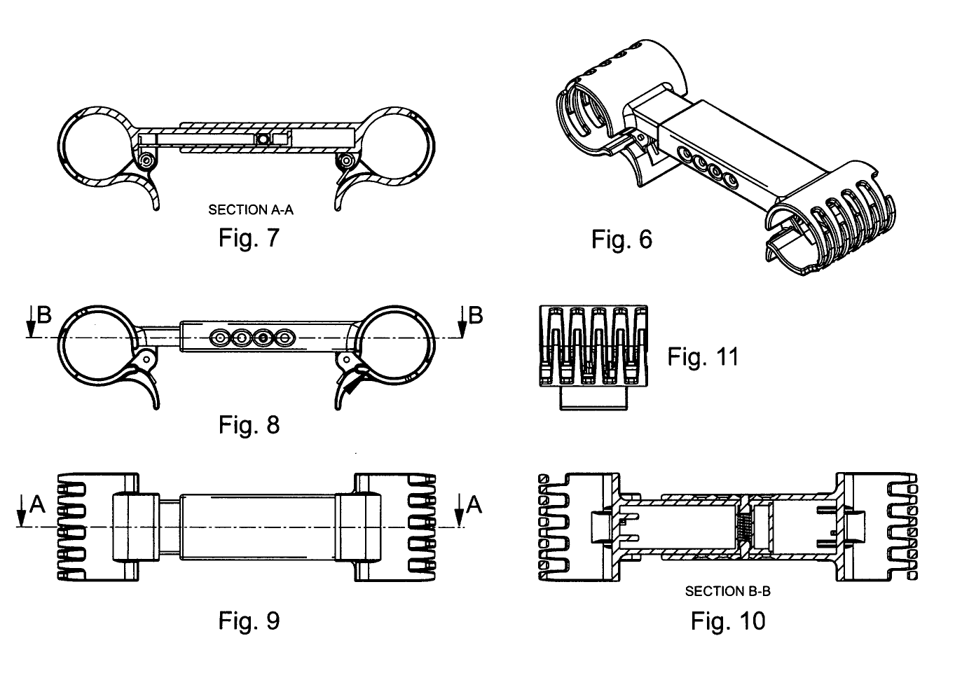

Another aspect of the present invention provides the advantage that the spacing between perambulators can be changed according to the user's requirements by providing a coupling element that is translationally extendable. When the coupling element has been extended to give the required spacing been perambulators, it can also be securely locked in place. An example of this alternative embodiment is shown in FIGS. 5 to 11 inclusive. Referring briefly to FIGS. 5 to 11, in which like parts have the same reference numerals, there is shown a clamp comprising an inner portion 101, that is adapted to move with respect to clamp outer portion 104. Moving teeth portions 102 are provided and are adapted to grip by way of a resiliently deformable device, such as a spring 103. Back plate 105 acts to contain lock pins 106 and a lock pin spring 107 within a volume defined between the back plate and the clamp. Apertures 110, 112, 114 and 116 receive sprung lock pins 106, thus permitting the clamp to be extended or retracted so as to connect together items or devices (not shown) which span different distances.

Although the present invention has been described hereinabove with reference to specific embodiments, the present invention is not limited to the specific embodiments and modifications will be apparent to a skilled person in the art which lie within the spirit and scope of the present invention. For example, the embodiment in which each of the jaw portions is attached to the coupling element in a hinged manner could also comprise a coupling element that is translationally extendable. In an alternative embodiment, the coupling element does not have to be extendable so that the spacing between gripping members is fixed.

Also, in the embodiment in which the angle between the gripping members and the coupling element is adjustable, the gripping members car comprise jaw portions, which can include teeth that can interdigitate and wings for ease of manual operation. This embodiment can also include a coupling element that is translationally extendable.

In addition, the direction of lateral extension of the coupling element; i.e., the sides of the coupling element where gripping no are not provided, can be left free for artistic design. For example, when the device of the present application is to be used for connecting children's pushchairs, the coupling element could comprise a picture of an animal or clown's face. The coupling element is also not limited to being elongate, but could also be square, circular or any other suitable shape, including, for example, the shape of a cartoon character.

The invention has been described by way of example only and it will be appreciated that variation may be made to the embodiments described without departing fin the scope of the invention. For example, the invention may be used to couple trolleys, carts, wheelchairs or other similar devices

1. A device for interconnecting perambulators, comprising:
a coupling element extending laterally in a first direction; and
fastening devices at opposing ends of said coupling element, each said fastening device comprising:
opposing resilient jaw portions adapted to grip a support member of a perambulator,
wherein said jaw portions are relatively hinged and adapted to be pivotable about an axis at an angle to said first direction.

2. The device according to claim 1, wherein:
said angle is substantially perpendicular.

3. The device according to claim 1, wherein:
the jaw portions include wings extending from said jaw portions to allow manual operation of said jaw portions.

4. The device according to claim 1, wherein:
said jaw portions are adapted to be pivotable substantially in a plane with said first direction.

5. The device according to claim 1, wherein:
said jaw portions are adapted to meet in a dosed position so as to fully encircle said support member.

6. The device of according to claim 5, wherein:
said jaw portions have a length greater than a diameter of said jaw portions when the jaw portions are in a dosed position.

7. The device according to claim 1, wherein:
each said jaw portion comprises teeth and said jaw portions are arranged so that said teeth interdigitate when said jaw portions are in a closed position.

8. The device according to claim 1, wherein:
each of said jaw portions is attached to said coupling element in a hinged manner.

9. The device according to claim 1, wherein:
said coupling element comprises a first portion and a second portion, said first portion being adapted to translationally receive said second portion.

10. The device according to claim 9, wherein:
said first portion comprises at least one aperture and said second portion comprises at least one releasably engageable locking pin adapted to engage said at least one aperture.

11. The device of according to claim 9, wherein:
said first portion comprises at least one pair of opposing apertures, and
said second portion comprises at least one pair of opposing releasably engageable locking pins adapted to engage said at least one pair of opposing apertures.

12. The device of according to claim 10, wherein:
said at least one locking pin engages said at least one aperture at an angle substantially perpendicular to said first direction.

13. A device for interconnecting perambulators, comprising:
a coupling element extending translationally in a first direction and comprising at least two components adapted to be moveable relatively translational in said first direction to adjust the length of said coupling element in said first direction; and
gripping members at opposing ends of said coupling element adapted to grip a support member of a perambulator,
wherein said gripping members extend in a second direction substantially perpendicular to said first direction and said second direction is greater than a diameter of said gripping members when said gripping members are in a dosed position.

14. The device according to claim 13, wherein:
said gripping members are pivotably attached to said coupling element so that an angle between said first direction and said second direction is variable substantially in a plane with said first direction.

15. The device of according to claim 13, wherein:
said at least two components comprise a first portion and a second portion, said first portion being adapted to translationally receive said second portion.

16. The device according to claim 15, wherein:
said first portion comprises at least one aperture; and
said second portion comprises at least one releasably engageable locking pin adapted to engage said at least one aperture.

17. The device according to claim 15, wherein:
said first portion comprises at least one pair of opposing apertures, and
said second portion comprises at least one pair of opposing releasably engageable locking pins adapted to engage said at least one pair of opposing apertures.

18. The device according to claim 16, wherein:
said at least one locking pin engages said at least one aperture at an angle substantially perpendicular to said first direction.

19. The device according to claim 13, wherein:
said gripping members comprise opposing resilient jaw portions.

20. The device of according to claim 19, wherein:
said jaw portions are relatively hinged and adapted to be pivotable about said second direction.

21. The device according to claim 19, wherein:
the jaw portions include wings extending from said jaw portions to allow manual operation of said jaw portions.

22. The device according to claim 19, wherein:
said jaw portions are adapted to meet in a dosed position so as to fully encircle said support member.

23. The device according to claim 19, wherein:
each said jaw portion comprises teeth; and
said jaw portions are arranged so that said teeth interdigitate when said jaws are in a dosed position.

24. The device according to claim 19, wherein:
each of said jaw portions is attached to said coupling element in a hinged manner.

25. (canceled)
